(19) United States
(12) Patent Application Publication
(10) Pub. No.: US 2006/0210775 A1
(43) Pub. Date: Sep. 21, 2006

(54) Glazing laminates

(75) Inventors: Ferenc Cser, Dianella (AU); Lloyd M Callard, Kinross (AU)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Tropiglas Pty. Ltd., Dianella (AU)

(21) Appl. No.: 10/471,272

(22) PCT Filed: Mar. 8, 2002
(86) PCT No.: PCT/AU02/00265

§ 371 Date: Mar. 24, 2004

(30) Foreign Application Priority Data
Mar. 8, 2001 (AU) PR 3621

(51) Int. Cl. B32B 23/02

(52) U.S. Cl. 428/192

(57) ABSTRACT

There is provided a glazing laminate comprising a polyvinyl butyral core layer having polyvinyl butyral/IR dye layers on each side. The dye containing layers are solvent cast from methanol onto the core layer. The dyes in each layer are different comprising BN 18 type PVB containing either 2 mg Epoline III-125 or 2 mg of Epolite III-57 dyes per grams of resin and dissolved in 10 ml of analytical grade of methanol for casting. The polymer is sandwiched between two glass layers under pressure and heat treatment at 135-140° C. An overall concentration of the dyes of ˜0.1 g/m2 results in an energy absorption over 65%. The heating effect of absorption is reduced by conduction through the polymer to the laminate edges, internal reflection, spherical reradiation and the relative insulative effect of the glass layers.

### BACKGROUND OF THE INVENTION

This invention relates to glazing laminates.

This invention has particular but not exclusive application to glazing laminates for glazing in construction, and for illustrative purposes reference will be made to such application. However, it is to be understood that this invention could be used in other applications, such as automotive glass and the like.

A significant contributor to the cost of running commercial buildings or maintenance of comfort in residences is the energy required to provide control of the internal climate of the building. In buildings in hot climates having windows that are exposed to a relatively high flux of solar radiation, or buildings with large areas exposed to solar radiation, a major cost is air cooling by airconditioning.

The conventional means of controlling heat passage into a building is to reduce the flux of solar radiation through the glazing by tinting to reduce a broad spectrum of radiation passing through the glass, with or without the provision of an outer partially reflective layer. By these means, a reduction of the total flux effects a partial reduction of the heat transmitted to the interior of the building. Clear window glass has a natural absorption maximum in the UV spectrum. Whilst the UV part of the solar spectrum at the Earth's surface is of high energy, the proportion of the total EM flux in the UV at the earth's surface is quite small due to upper atmospheric absorption. The visible spectrum is not substantially absorbed by clear window glass, but is quite strongly absorbed by tinted glass. The absorbed energy is converted to heat, which is in part spherically radiated in the infrared, and otherwise dispersed by convective transfer and conduction. The infrared component of the incident light is generally transmitted directly (with refraction) to the interior of the building in addition to the internally directed IR component arising from absorbed visible/UV radiation. In terms of energy density, the IR/visible bands contribute the greatest part if the incident energy density transmitted to the interior of a building through the windows or glass walls.

In fact, energy density reaches a maximum at a wavelength of about 600 nm, with about 90% of the energy of solar radiation incident at the earth's surface being of wavelengths between 500 nm and 1750 nm, with several distinct maxima.

Where tinting and/or partially reflective films is used, this generally reduces the visible flux and requires stronger lighting, which carries its own heat burden. In the case of tinting alone, the heat loading transmitted is only reduced by the proportion of IR reradiation back out of the building.

International patent publication WO97/44690 discloses an optical element comprising a transparent layers comprising one or more passive layers and one or more active layers wherein said passive layers facilitate the transmission of electromagnetic radiation in a substantially unaltered form and the at least one active layers include an active material dispersed through the active layer and having the capacity to intercept electromagnetic radiation of a wavelength or range of wavelengths and redirect some of the energy of the intercepted radiation into the interior of the optical element, the layers being in face to face relationship and being optically coupled to each other. The described embodiments use a luminophore as the active material to absorb IR in the active layer and to spherically reemit IR by luminescent decay of the luminophore from the excited state.

The basic concept of causing dissipation of IR by absorbance dye in a polymer film was shown to work, but no practical polymer film was produced.

### SUMMARY OF THE INVENTION

This invention in one aspect resides broadly in a laminated glazing sheet including at least one polymer layer having dispersed therein at least two dyes selected to absorb IR radiation of different or overlapping ranges of frequencies, said ranges including frequencies corresponding to IR intensity peaks in incident solar radiation, and at least one UV absorbent outer support layer. The at least two dyes may be dispersed in one, both or more of the polymer layers depending on the number of layers, choice of polymers and compatibility of the dyes in polyemer dispersion in practice.

The polymer layer may include a tint such as by means of a dye absorbing in the visible band. A practical difficulty experienced with such constructs is that suitable dyes tend to be barely compatible with the polymer matrices in which they are dispersed, and may be reactive with the IR dyes. The problems range from lack of homogeneity in monolayer films, films changed colour and destroyed the IR properties, and when laminated in two layers to keep the dyes separate, the panels were blotchy, patchy, uneven in colour and torn.

Accordingly, in a further aspect this invention resides in a laminated glazing sheet including at least two polymer layers having dispersed therein respective dyes, said layers having between them at least two dyes selected to absorb IR radiation of different or overlapping ranges of frequencies, said ranges including frequencies corresponding to IR intensity peaks in incident solar radiation, at least one other of said layers including a dye absorbing in the visible spectrum, a polymer interlayer between adjacent dye bearing ones of said polymer layers, and at least one UV absorbent outer support layer.

The absorbed IR radiation will be for the most part dispersed in the laminate as heat. In order to minimize the heat transmitted to the interior of the building, the heat is preferably dispersed from the laminate to reduce heat build-up and the black body effect to the interior of a glazed structure.

Accordingly, in a yet further aspect the present invention resides broadly in a laminated glazing element including an optically clear laminated sheet including at least two polymer layers having dispersed therein respective dyes, said layers having between them at least two dyes selected to absorb IR radiation of different or overlapping ranges of frequencies, said ranges including frequencies corresponding to IR intensity peaks in incident solar radiation, said polymer layers being sandwiched between a UV absorbent outer support layer and an insulative inner support layer, said glazing element having at least one edge portion associated with a heat sink selected to disperse heat from said laminated sheet.

The inner support layer is of an insulative material to reduce heat transfer to the interior of a glazed structure by convection. The at least one polymer layer may be selected from polymers that have a higher then usual thermal conductivity, and that the heat sink be configured to disperse heat to the outside of the glazed structure from the at least one edge thereof. For example, the heat sink may be a thermal mass being configured to either or both of radiate and convect heat to the exterior. Alternatively, the heat sink may be configured to selectively disperse the heat to the interior or exterior of the glazed structure. By this means, in winter the filtered IR may be used to heat the building, whilst in summer the trapped heat is disposed to the exterior. In one embodiment the heat sink is the atmosphere per se, rendered useful by installing the laminate having the at least one edge exposed.

The relative refractive indices of the inner and outer support layers and the at least one polymer layer may be selected to maximize the amount of black body radiation which is internally reflected to the edges of the laminate.

### DETAILED DECRIPTION OF THE INVENTION

The polymer material comprising respective ones of the at least two polymer layers may be the same or different from each other, and may respectively be the same or different from the polymer interlayer. In order to provide a constant refractive milieu, the polymer of the at least two polymer layers are the same, and preferably all polymers layers are of the same material. The polymers may be of any known optically clear film forming or castable thermoplastic or thermoset resin, selected on the basis of compatibility with the respective dyestuffs.

The respective polymers may be formed into films and assembled into the layered structure in an appropriate forming process such as pressing with or without the application of heat, or the like. Where the polymers are extrudable thermoplastics, the layers of polymer may be concurrently formed such as by coextrusion. For example, where the polymers permit, the polymer layers may be formed by a melt blowing process such as the double bubble process for the production of laminated films.

In order to permit intimate lamination of the polymers with disparate materials such as glass by thermal pressing or the like, the polymer may be a thermoplastic or a crosslinked polymer that is thermoplastic or thermoset with a thermoplastic uncrosslinked form.

The polymer may be selected as to refractive index relative to the UV absorbent outer support layer so as to provide for a degree of total internal reflection of spherically dispersed long-wave IR emanating from the polymer layers in use. By this means a degree of selective transmission of energy absorbed by said dyes is to the periphery of the sheet by conduction and a degree of total internal reflection.

The respective dyes may be selected having regard to compatibility with the polymer of choice. The IR dye may for example be selected from organic dyes, aminium, bisammonium and bisimmonium salt dyes, or metal salts of organic acids. It has surprisingly been found that polyvinyl butyral (PVB) polymers are compatible with aminium, bisammonium and bisimmonium salt dyes, a specific class of dyes which are generally N-organic salts in which the counter anion is derived from the salt of a strong acid such as ClO₄⁻, PF₆⁻, AsF₆⁻, SbF₆⁻ and the like. For example the dye may be divalent immonium salts which are near infrared dyes of the formula (I).
(R₂NAr)₂—N⁺═Ar^{t}═N⁺R₂+2X⁻ (I)
wherein R═C₁ to C₆ alkyl; Ar=divalent phenyl which may or may not be ring substituted with one or more alkyl, alkoxy, halogen, nitro, cyano or carboalkoxy groups; Ar^{t}=quinoidal phenyl which may or may not be ring substituted with one or more alkyl, alkoxy, halogen, nitro, cyano or carboalkoxy groups; and X=an anion of a strong acid, such as an SbF₆⁻ anion.

Experimental work such as that of Resch-Genger U. and Wolfbeis, O., “Near Infrared Dyes for High Technology Applications”, (Kluwer Academic Publishers) has resulted in the production of a series of such dyes including those of the Epolin series. Typical structures of amimium and bisammonium salt dyes are given in formulae II and III respectively.

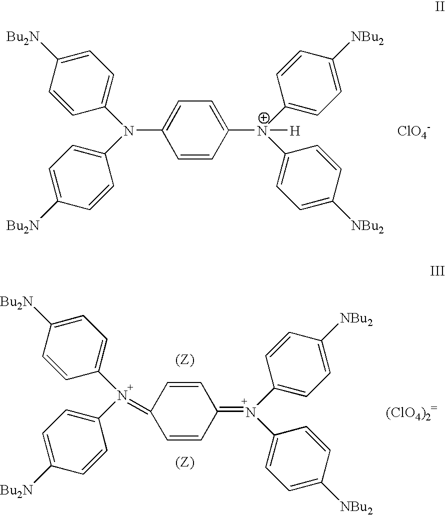

It is envisaged that many other polymer/dye combinations may be appropriate. The visible spectrum dyes may be selected from dyes known for the purpose.

The dyes may be dispersed in the polymer layers by any suitable means. The dyes may for example be directly blended into the polymer material prior to casting or forming the polymer layer. Alternatively, the dye may be dissolved in a solvent which is preferably a cosolvent for the polymer, whereby the polymer layer may be formed as a cast film by solvent evaporation.

The UV absorbent outer support layer is preferably glass, but may also be a further polymer layer doped with a suitable UV absorbent substance. The UV absorbent outer support layer is preferably selected to have refractive qualities relative to those of the polymer layers whereby the boundary between the polymer layer and the UV absorbent outer support layer forms a surface for internal reflection of longwave IR emitted by the warmed polymer layers.

According to a further preferred feature of the invention at least a portion of the edge of the optically clear laminated sheet is configured to facilitate emission of the emitted radiation from the optical element. In one form at least some of the edges may be chamfered. Alternatively the sheet edges may be in contact with an absorber comprising a conductive thermal mass such as metal. The thermal mass may include means to disperse heat to the outside of the building, or to convective chimneys in the walls. The heat may be recovered by exchange means such as water to be harvested for heating or heat pump applications.

At least one face of the optically clear laminated sheet may be formed with a discontinuity to facilitate the emission of emitted radiation from the optical element. The form of discontinuity may comprise at least one groove formed in the at least one face. Another form of discontinuity may comprise one or more depressions or dimples provided in the at least one face. Another form of discontinuity may comprise at least one rib or protrusion on the at least one face. Another form of discontinuity may comprise an etched surface on a portion of the at least one face.

It has surprisingly been determined that the suitability of a particular dye/polymer combination in a film does not in general predict the performance or stability of the polymer layers in a laminate. Without wishing to be bound by theory, it is believed that the dyes in adjacent layers of a laminate exhibit a cross reactivity that can affect the IR performance, the stability of the dye systems, and even the physical properties of the polymers in the laminate.

It has been found that the provision of a polymer interlayer reduces the interactions between the respective dye/polymer systems, and that as a preference the same polymer may be used in the dye-containing layers and interlayers to provide a substantially consistent refractive qualities in the visible band. It has been found that the provision of a UV absorbent outer layer tends to improve the stability of the polymers and polymer/dye systems.

In one aspect the invention resides in a method of forming a glazing laminate including the steps of:
(a) solvent casting a polyvinyl butyral film;
(b) solvent casting a polyvinyl butyral/dye film to each surface of said polyvinyl butyral film, said polyvinyl butyral/dye films collectively including at least two dyes selected to absorb IR radiation of different or overlapping ranges of frequencies, said ranges including frequencies corresponding to IR intensity peaks in incident solar radiation; and
(c) laminating the multilayer film of step (b) between glass sheets under heat and pressure.

It has further been determined that certain compositions for film forming by solvent evaporation and comprising relatively reactive dyes and polymers having reactive groups may be stabilized by selection of the solvent. For example, polyvinyl butyrals are polymers having significant hydroxyl functionality. Such polymers are usually worked up and are stable in technical grade ethanol. Aminium salt dyes such as the EPOLIN dyes are also generally worked up in polar solvents such as acetone, and are reasonably soluble in ethanol. However, in the use of polyvinyl butyral in forming the dye containing polymer layers of the present invention, the PVB/ethanol//dye/ethanol and PVB/ethanol//dye/acetone systems results in films of poor physical characteristics and markedly reduced IR performance. The films so produced were also intractable in being formed up under heat and pressure to glass substrates, with excessive bubble formation.

However, despite limited solubility of aminium salt dyes such as aminium salts in methanol, it has been surprisingly found that solvent cast films based on a PVB/methanol//dye/methanol system exhibit superior film forming and dye-stability performance. The polymer compositions formed by this system have also shown an ability to be subsequently melt-processed such as by extrusion into films with suitable physical and IR dye performance.

In a further aspect the present invention relates to a film forming polymer composition comprising a mixture of methanolic solution of a polyvinyl butyral having a hydroxyl content of at least 18 wt % and a saturated methanolic solution of an aminium salt IR absorbing dye.

In a yet further aspect of the present invention, there is provided a method of forming an IR absorbing polymer film comprising the steps of forming a mixture of methanolic solution of a polyvinyl butyral having a hydroxyl content of at least 18 wt % and a saturated methanolic solution of an aminium salt IR absorbing dye, forming said mixture into a liquid layer, and drying said layer to a film by solvent evaporation.

In a yet further aspect of the present invention, there is provided a method of forming an IR absorbing polymer film comprising the steps of forming a mixture of methanolic solution of a polyvinyl butyral having a hydroxyl content of at least 18 wt % and a saturated methanolic solution of an aminium salt IR absorbing dye, drying said mixture, and melt extruding said dried mixture to form a film.

It has further been determined that such cast and extruded films may include more than one dye and may further be laminated to form an optically clear laminated sheet. Accordingly, in another aspect there may be provided an optically clear laminated sheet including a polymer layer comprising a polyvinyl butyral having a hydroxyl content of at least 18 wt % and at least one aminium salt IR absorbing dye, said dyes being selected to absorb IR radiation of different or overlapping ranges of frequencies, said ranges including frequencies corresponding to IR intensity peaks in incident solar radiation, and at least one UV absorbent outer support layer, wherein said polymer is formed by forming a mixture of methanolic solution of said polyvinyl butyral having a hydroxyl content of at least 18 wt % and a saturated methanolic solution of said dyes, and drying said mixture.

In order that this invention may be more readily understood and put into practical effect, reference will now be made to the following examples which illustrates preferred embodiments and comparative formulations in respect of the invention, and wherein:

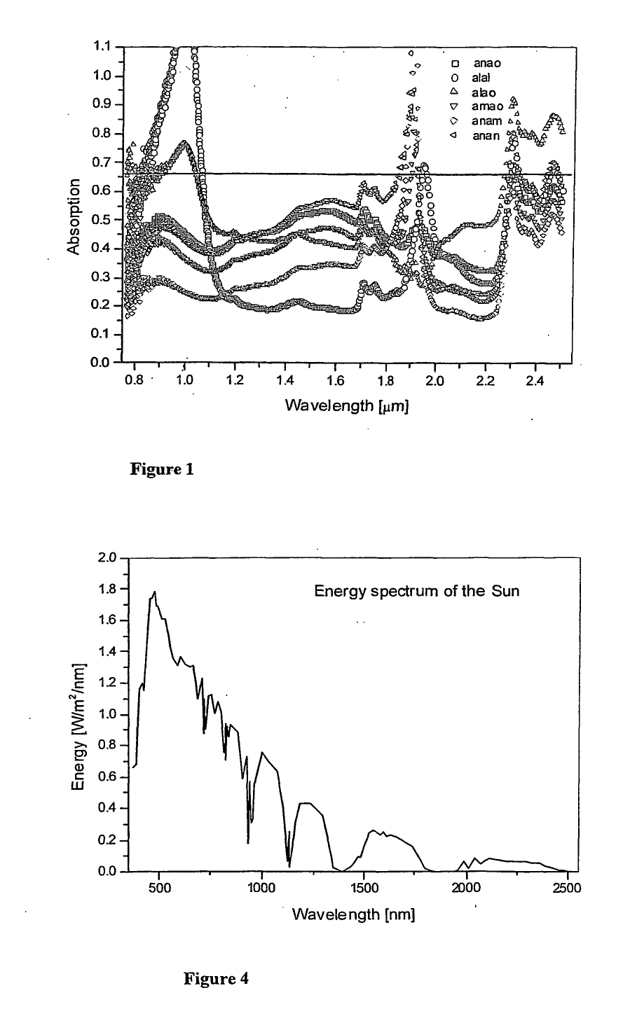

FIG. 1 is a FT-NIR absorption of dye combinations in polymers in accordance with the present invention;

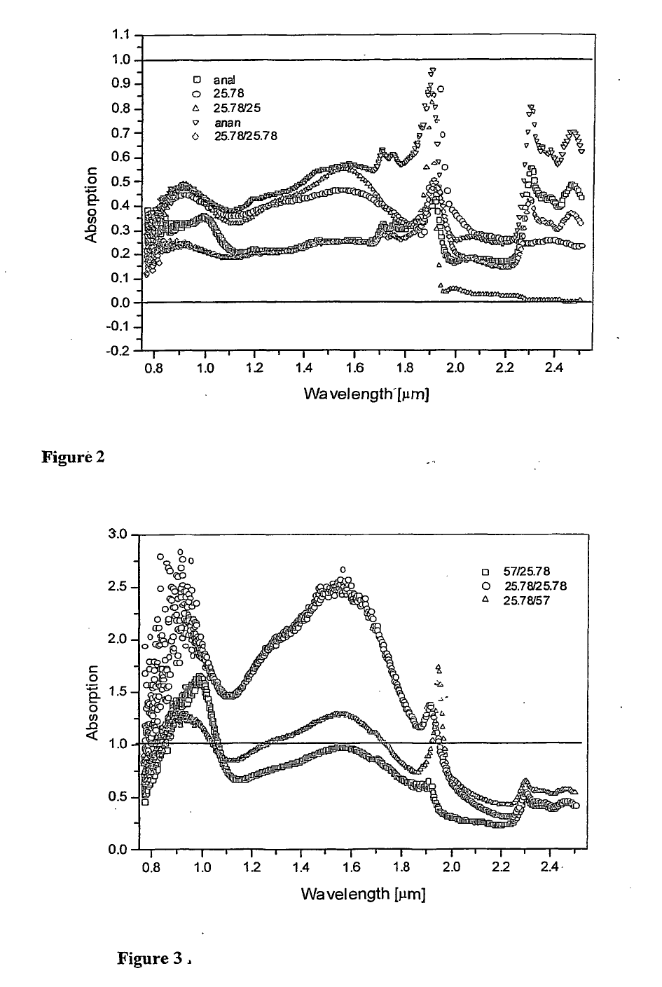

FIG. 2 is a FT-NIR absorption of Epolite 125 and Epoline III-57 combinations in polymers in accordance with the present invention;

FIG. 3 is a FT-NIR absorption of Epolite dye combinations in polymers in accordance with the present invention;

FIG. 4 is the energy spectrum of the Sun;

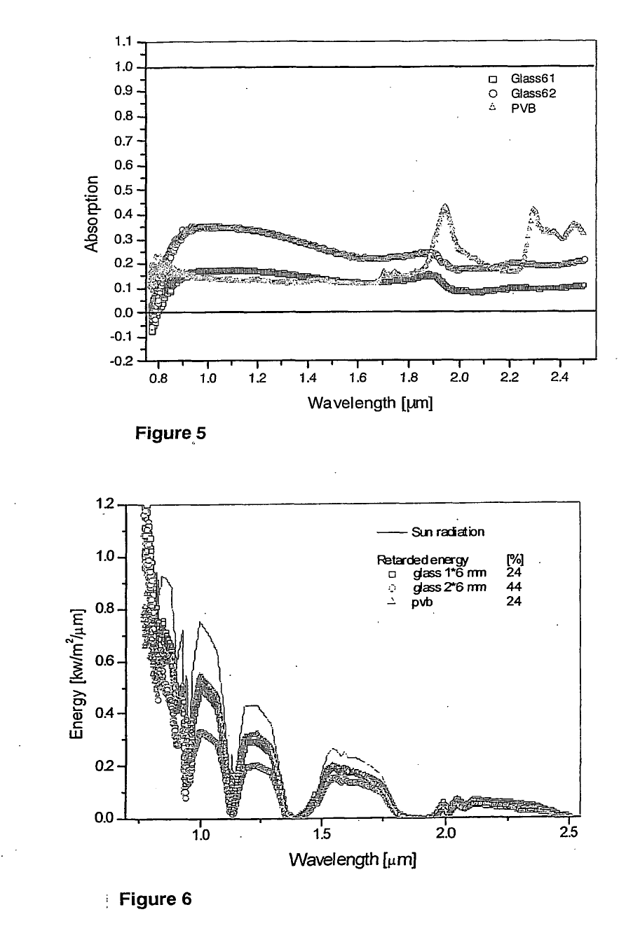

FIG. 5 is the energy absorption of laminates of glass and PVB;

FIG. 6 is the energy absorption of some Epolin combinations;

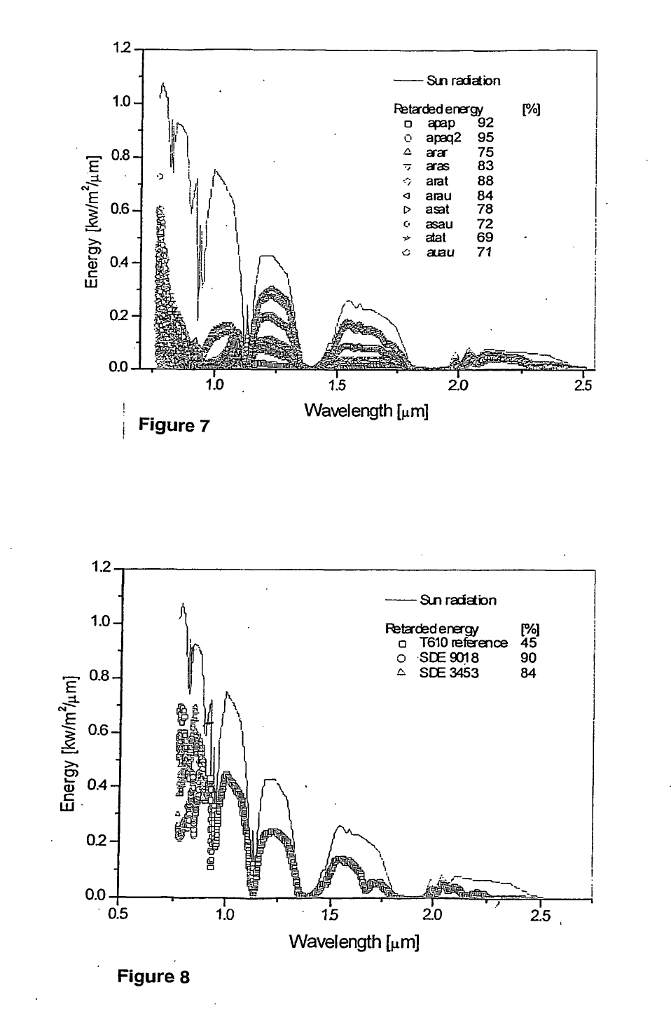

FIG. 7 is the energy absorption spectra of H.W. Sands dye systems;

FIG. 8 is the energy absorption spectrum of a sample;

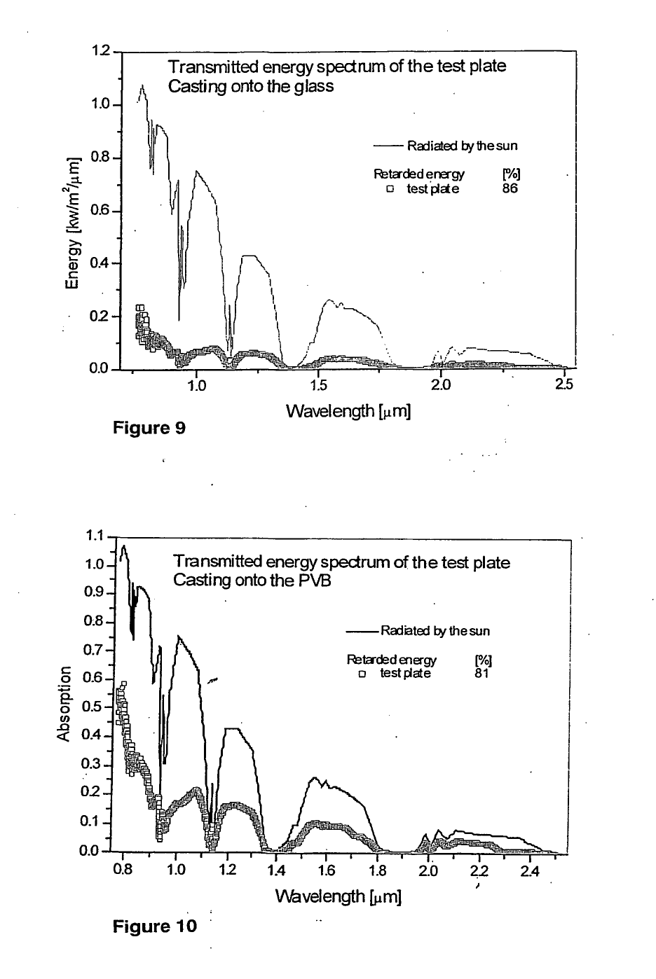

FIG. 9 is the energy absorption spectrum of a sample, and

FIG. 10 is the energy absorption spectrum of a sample.

### EXAMPLE 1

Methanol was tested for the dissolution of the dyes and of the PVB. BN18 polymer (Wacker-Chemie, PIOLOFORM) was used.

Initally 2 mg dye/1 g of PVB mixture was produced and dissolved in ethanol forming a ˜40% solution with respect to the resin. This solution was diluted by methanol to have an overall concentration of 20% of resin. The glass plates were cast in consecutive steps by this solution. During the drying process the layer turned to be turbulent then it cleared. The next consecutive layer was cast in this stage. A dye density of 0.010-0.026 g/m2 covered the individual slides. Additional layers of PVB were cast to have an expected layer thickness of 0.05 mm after the heat treatment. Following by an overnight drying the slides were heat treated at 135° C. for 5-10 min. Two slides were pressed together to have a homogeneous and transparent layer.

Four dyes were tested. Epolite 125-(AN), Epolite 178 (AM), Epoline III-57 (AL) and Spectra IR 920 (AO). The combinations and their properties are shown in Table I.

TABLE 1

| | | | Thickness, |
|---|---|---|---|
| Combination | Density of dyes, g/m² | IR930 absorption, % | μm |
| AN-AN | 0.052 | 57 | 515 |
| AN-AM | 0.050 | 50 | 495 |
| AN-AL | 0.047 | 53 | 473 |
| AN-AO | 0.038 | 60 | 517 |
| AM-AM | 0.049 | 33 | 412 |
| AM-AL | 0.060 | 67 | 450 |
| AM-AO | 0.046 | 50 | 530 |
| AL-AL | 0.065 | 87 | 525 |
| AL-AO | 0.059 | 67 | 525 |
| AO-AO | 0.017 | 17 | 522 |
| PVB | 0 | 3 | 552 |

The near infrared (NIR) spectra of the samples were determined by a Perkin-Elmer FT spectrometer from 13000 to 4000 cm⁻¹ energy range what corresponds to the wave length of 670 to 2500 nm. FIG. 1 shows the absorption spectra of the different combinations.

Epoline III-57 has an extraordinary high absorption at the wavelength near to 1000 nm but it has practically no absorption at longer wavelengths. Epolite 125 has good absorption at the lower wavelengths but it is relatively ineffective at the higher energy range. The IR absorption of the combinations of these two dyes are shown in FIG. 2.

Next a solution of Epolite 125 and Epolite 178 was prepared in pure methanol in 8 mg dye/1 g of resin. Epolite 178 did not dissolve completely in the solution. One layer of this solution was cast on glass and combined by itself and by double layers of Epoline III-57 of 1 mg dye in 1 g of resin of the methanol solution. The density of the dye and the IR930 absorption with the layer thickness are given in Table II.

TABLE II

| | | | Thickness, |
|---|---|---|---|
| Combination | Density of dyes, g/m² | IR930 absorption, % | μm |
| 57/25.78 | 0.06/0.95 | 92 | 300 |
| 25.78/57 | 0.95/0.06 | 86 | 320 |
| 25.78/25.78 | 2.36 | 95 | 135 |
| 57/57 | 0.11 | 90 | 230 |

Transparent layers of yellow/green colour were formed. The FT-NIR absorption of the layers are shown in FIG. 3.

The layers have extremely high NIR absorption. There might be some scaling error in the equipment showing absorption values higher than 1.

The IR930 absorption values correspond to the FT-NIR data. Epolite 125 assures high absorption values at longer wavelength, Epoline III-57 assures the good absorption at the range of 1000 nm, what corresponds to the middle of the IR energy peak of the incident solar radiation spectrum (see in FIG. 4).

The FT-NIR absorption of the PVB with a layer thickness of 0.5 mm enclosed in between two glass sheets of 1 mm thickness is shown in FIG. 5. The Figure also shows the absorption of a single and a double sheets of glass plates of 3 mm thickness. This kind of glass plates is supposed to be used for the final sample preparation.

PVB has homogeneously low absorption up to a wavelength of 2000 nm, than there are two absorbing bands. These bands are also visible in FIGS. 1-3. The thick glass plates show higher and homogeneous absorption level for the whole range with a broad peak at the 900-1400 nm range.

Conclusion

Epolite 125 and Epoline III-57 dyes are suitable for the preparation of the laminates. They can be employed in a concentration of 0.1-0.3 g/m². This amount of dyes can be cast as couple of layers of 2 mg dye in 1 g of BN18 resin from a methanol solution on a glass surface. The necessary layer thickness is achieved by casting of additional layers of PVB from methanol solution. Two coated glass surfaces are heated and pressed together after having been properly dried at temperature of 135° C. to form the laminated glass of the present invention.

### EXAMPLE 2

Two new dyes were obtained from Epolin Inc. for the purpose of producing blue and grey laminates. The dyes were Sole Blue 33 and Violet B. Epolin give the ratio of colour dye with respect to IR dye of 0.1-0.15 w/w.

Types of PVB (BN18) and glass used were as previously reported. Methods for preparation were used as previously developed.

Results

Sole Blue 33 dissolved well in methanol (5 mg/10 ml) but Violet B was soluble only up to 1 mg/10 ml.

Initial experiments on a small scale were carried out to match the colour to blue or gray from that of the IR dye (i.e. green-yellow). Levels of the new dye of 0.1, 0.3 and 1 w/w dye per IR dye were tested. 4 mg/g IR dye with respect to PVB was used dissolved in 10 ml MeOH/g of PVB.

Sole Blue 33 dissolved properly at each concentration. However, it did not produce a good colour match—it formed various green colours. Violet B did not dissolve perfectly at the highest concentration—it also produced only a yellow-brown colour. Some particles remained not dissolved at each concentration indicating some inhomogeneities in the dye. During heat treatment at 135° C. the undissolved part of Violet B dissolved and produced very heterogeneous samples i.e. the colour varied throughout the sample.

It was theorized that new solvents were needed to overcome these problems. Acetone/butanol-1 (4:1) solvent was selected for the next set of experiments, 2 mg/g IR dye was used (1.25 mg/g Epolight III-57 and 0.75 mg/g Epolight III-25 with respect to the PVB). Violet B was added at 0.3 w/w with respect to the IR dye. 10 ml acetone mixed with 2.5 ml butanol-1 was used for 1 g of PVB.

A clear grey colour formed. 2 or 3 layers of mixture were cast to glass, dried and heat treated at 135° in the oven, as required to form the flat adhered laminate structure needed for window glass. Unfortunately, the colour changed. The grey became violet. FTNIR spectra showed that the IR dye function had been destroyed, its initial good IR absorption decreased to less than one third of its initial value. IR transmission measured by laser showed the same result.

These results show that the Violet B dye destroyed the IR dye after a short heat treatment at 135° for 3-5 min.

To overcome this problem a sample was prepared with two separate layers, one layer containing Violet B and one the IR dye.

A 400×400 ml panel was prepared using two independent layers, one with IR dye cast to one glass plate, the other with Violet B to the other glass plate. The IR dye containing layer was prepared using 128 mg of IR dye (80 mg Epolight III-57 and 48 mg of Epolight III-125) mixed to 32 g of PVB (4 mg/g), what corresponds to 0.8 g dye/m². The other layer contained 53 mg of Violet B dispersed in 32 g PVB (0.4 w/w Violet blue with respect or IR dye). Both glasses were cast in two steps using acetone/butanol-1 solvent and the solvent was evaporated overnight.

Heat treatment in the oven at 135° was performed for 5 min and then the plates were pressed together. During the heat treatment a 5 kg weight was on the laminate, as previously developed. During this treatment the layer of Violet B unexpectedly coagulated, lost its lamellar shape and formed totally inhomogeneous laminate. The IR dye containing layer remained intact as expected—FTNIR spectra of the system showed that absorption was homogeneous across the layer, indicating that the IR dye remained intact. There was a small reduction in absorption power in some spots where there was a high concentration of Violet B. Hence the problems with the large panel were related to the unexpected effects of the Violet B dye on the laminate. The visual aspect of the panel is blotchy, patchy, with some tears in the layer structure. The colour is very varied from yellow to blue.

Conclusion

Violet B is chemically not neutral with respect to IR dyes. It destroys the activity of the IR dyes at higher temperatures within a short time. The dyes should not be mixed in one layer OR a different violet dye is needed.

The surface tension of the PVB makes the two layered techniques vulnerable. The smallest inhomogeneity in the layer thickness is apparent as a colour variation.

The greenish-yellow colour of the IR dye was matched to gray (before heating) but much higher levels of Violet B were needed than expected, hence the transparency of the laminate was decreased significantly.

| | | | |
|---|---|---|---|
| ATAU | 0.100 | 96 | 66 |
| AUAU | 0.038 | 96 | 71 |
| ASAU | 0.108 | 97 | 94 |
| ASAV | 0.069 | 93 | 92 |
| AUAU | 0.091 | 97 | 71 |
| AUAV | 0.098 | 80 | 76 |
| AVAV | 0.085 | 97 | 75 |

The FTNIR data and the calculation supported the IR930 absorption data The overall energy absorption is less than IR930 in the case of Epoline III-57 due to its lower absorption at longer wave length. Some of the energy transmittance curves are shown in FIGS. 5 to 7.

In a comparison of H.W. Sands SDA 2072 to Epoline dyes, this corresponds to Epoline III-125. They FTNIR absorption curves are identical.

The glass with 5 mm of thickness has an energy absorption value of 24%, two glass plates have 44%, 0.5 mm thick PVB between two microscope slides has 24%.

The Final Samples

The first sample was prepared using Epoline III-125 and Epolite III-57. First 50-50 and 100-100 mm sample sizes were tested and coated. The necessary layer thickness was achieved using multiple layers from PVB. The layers cracked after a complete drying and partly pealed from the glass surface. The resulted laminates were inhomogeneous, the cracks could not have been eliminated neither by pressing together or at higher temperatures. The 50-50 mm samples were FT-NIR tested and their energy absorption was found to be 73-86%.

A second sample was prepared using the Du Pont PVB film (0.375 m). The glass surface was covered by one layer of BN 18 type of PVB containing either 2 mg Epoline III-125 or 2 mg of Epolite III-57 dyes per grams of resin and dissolved in 10 ml of analytical grade of methanol. The layers were dried overnight than two glass plates containing different dyes were pressed together with an inner layer of Du Pont PVB film. The glass laminates were put into an oven preheated to 135° C. and kept there for 15-20 min. The laminates formed transparent layers.

The energy absorption of the laminates was tested on 50-50 mm samples. The samples were prepared for the weathering test. FIG. 8 shows the energy absorption spectrum of sample 122/126.

The integrated absorption values are:

Sample 122/126: 86%, sample 128/124: 73%, sample aq1/as1: 65% and as2/as2: 81%.

The homogeneity of the laminate was unsatisfactory. The dyed PVB layer showed a very strong surface tension and had the tendency to collect into lines during the evaporation of the methanol. The surface tension was big enough to remove the layer from great parts of the total surface. Disregarding the inhomogeneities the demonstration laminates showed excellent heat filtering when tested by an IR lamp. The hot component of the radiation of the lamp was missing. The reference laminate without dye showed a burning heat radiation.

A third laminate was prepared using glass plates of 5 mm. The dye containing PVB layer was not cast to the surface of the Du Pont PVB film. First Epoline III-125 was cast to the one side of the film, then Epolite III-57 on the other side. There was an overnight drying period between the two casts. The film was dried again for 20 hours and then used to form laminate. The 50-50 mm parallel sample showed good homogeneity and its energy absorption spectrum is shown in FIG. 9. The total absorption is 64% The density of the dyes is 0.14 g/m².

### CONCLUSION

IR dyes can be used to form laminates with heat resistant properties. An overall concentration of the dyes of ˜0.1 g/m² results in an energy absorption over 65%. The laminates formed after a heat treatment under pressure at 135-140° C. for 15-20 min are pale lemon. The laminates fill the requirements of the energy retardation. The heating energy is not absorbed by the system which would result in the increase of the glass temperature. The energy is conducted out of the laminate.

This kind of laminate may be used as security glazing for windows to reduce of the air conditioning costs of buildings in territories with very high solar heat radiation.

It will of course be realised that while the above has been given by way of illustrative example of this invention, all such and other modifications and variations thereto as would be apparent to persons skilled in the art are deemed to fall within the broad scope and ambit of this invention as defined in the claims appended hereto.

1. A laminated glazing element including an optically clear laminated sheet including at least two polymer layers having dispersed therein respective dyes, said layers having between them at least two dyes selected to absorb IR radiation of different or overlapping ranges of frequencies, said ranges including frequencies corresponding to IR intensity peaks in incident solar radiation, said polymer layers being sandwiched between a UV absorbent outer support layer and an insulative inner support layer, said glazing element having at least one edge portion associated with a heat sink selected to disperse heat from said laminated sheet.

2. The laminated glazing element according to claim 1, wherein said polymer layers are selected to have higher thermal conductivity than said inner support layer.

3. The laminated glazing element according to claim 1, wherein said heat sink is configured to disperse heat to either the interior or exterior of a glazed structure from the at least one edge portion.

4. A The laminated glazing element according to claim 1, wherein said heat sink is configured to selectively disperse the heat to the interior or exterior of the glazed structure.

5. The laminated glazing element according to claim 1, wherein said heat sink is a thermal mass configured to radiate and/or convect heat.

6. The laminated glazing element according to claim 1, wherein the IR dyes are selected from aminium, bisammonium and bisimmonium salt dyes.

7. The laminated glazing sheet according to claim 1, wherein said polymer layers are selected from polyvinyl butyral (PVB) polymers.

8. The laminated glazing element according to claim 1, wherein said polymer layers are selected from polyvinyl butryal (PVB) polymers.

9. The laminated glazing element according to claim 1, wherein the inner support layer has a range of colouring dyes.

10. The laminated glazing element according to claim 6, wherein one or more of the IR dyes have graduated wavelengths from 900 to 1700 nanometers.

11. The laminated glazing sheet according to any of the preceding claims, excluding claim 7, wherein said polymers layers are selected from methyl acrylate polymers.

12. The laminated glazing sheet according to any of the preceding claims 1 to 10, excluding claim 7, wherein said polymer layers are selected from polycarbonate polymers.

13. The laminated glazing sheet according to claim 7, wherein a plolyvinyl butral layer is complimented by a liquid polycarbonate polymer containing selected dyes.

14. A laminated glazing sheet including a polymer layer comprising a polyvinyl butyral having a hydroxyl content of at least 18 wt % and at least one aminium salt IR absorbing dye, said at least one dye being selected to absorb IR radiation of different or overlapping ranges of frequencies, said ranges including frequencies corresponding to IR intensity peaks in incident solar radiation, and at least one UV absorbent outer support layer, wherein said polymer layer is formed by forming a mixture of methanolic solution of said polyvinyl butyral having a hydroxyl content of at least 18 wt % and a saturated methanolic solution of said at least one dye, and drying said mixture.

15. A method of forming a glazing laminate including the steps of:
(a) solvent casting a polyvinyl butyral film;
(b) solvent casting a polyvinyl butyral/dye film to each surface of said polyvinyl butyral film, said polyvinyl butyral/dye films collectively including at least two dyes selected to absorb IR radiation of different or overlapping ranges of frequencies, said ranges including frequencies corresponding to IR intensity peaks in incident solar radiation; and
(c) laminating the multilayer film of step (b) between glass sheets under heat and pressure.

16. The laminated glazing element according to claim 7, wherein one or more of the IR dyes have graduated wavelengths from 900 to 1700 nanometers.

17. The laminated glazing element according to claim 8, wherein one or more of the IR dyes have graduated wavelengths from 900 to 1700 nanometers.

18. The laminated glazing element according to claim 9, wherein one or more of the IR dyes have graduated wavelengths from 900 to 1700 nanometers.
